(19) United States
(12) Patent Application Publication
(10) Pub. No.: US 2011/0206972 A1
(43) Pub. Date: Aug. 25, 2011

(54) POWER STORAGE DEVICE SEPARATOR

(75) Inventors: Takeshi Hashimoto, Shizuoka-shi (JP); Hiroki Totsuka, Shizuoka-shi (JP); Masanori Takahata, Shizuoka-shi (JP); Mitsuyoshi Takanashi, Shizuoka-shi (JP); Yasuhiro Oota, Shizuoka-shi (JP); Kazuhiko Sano, Shizuoka-shi (JP); Daisuke Tezuka, Shizuoka-shi (JP)

(73) Assignee: TOMOEGAWA CO., LTD., Chuo-ku, Tokyo (JP)

(21) Appl. No.: 13/123,005

(22) PCT Filed: Oct. 14, 2009
(86) PCT No.: PCT/JP2009/005365

§ 371 Date: Apr. 7, 2011

(30) Foreign Application Priority Data
Oct. 15, 2008 (JP) 2008-266786
Nov. 26, 2008 (JP) 2008-301428

(51) Int. Cl. H01M 2/16; H01G 9/155; H01G 9/00; B32B 5/02; D04H 1/54; B32B 5/26; C08L 1/02; D21H 27/30

(52) U.S. Cl. 429/144; 429/247; 361/502; 361/500; 428/221; 428/338; 442/411; 428/220; 428/311.11; 428/339; 524/35; 162/123

(57) ABSTRACT

Provided is a power storage device separator that is realized in the form of a heat-resistant, solvent-resistant, and dimensionally stable thin film. Also provided is a power storage device separator that can be realized in the form of a thin film which has excellent ion permeability and low resistance, which makes short-circuiting between electrodes and self-discharging difficult to occur, and in addition, which has excellent durability even after long periods of use under high temperature environments in the presence of organic solvents and ionic solutions.

### TECHNICAL FIELD

The present invention relates to a separator for a power storage device, in particular to a separator for a lithium ion secondary battery, a polymer lithium secondary battery, an electric double layer capacitor, or an aluminum electrolytic capacitor.

Priority is claimed on Japanese Patent Application No. 2008-266786, filed Oct. 15, 2008, and Japanese Patent Application No. 2008-301428, filed Nov. 26, 2008, the contents of which are incorporated herein by reference.

### BACKGROUND ART

Recently, electrical and electronic equipment have been increasingly demanded for both industrial and consumer use, and hybrid vehicles and so forth have also been developed. Thus, the demand for electronic components including lithium ion secondary batteries, polymer lithium secondary batteries, electric double layer capacitors, and aluminum electrolytic capacitors is remarkably increasing. These electrical and electronic equipment are getting higher and higher capacity and functions each day with rapid progress. Lithium ion secondary batteries, polymer lithium secondary batteries, electric double layer capacitors, and aluminum electrolytic capacitors are also required to have higher capacity and higher functions, and have been increasingly used in severer environments.

The lithium ion secondary battery and the polymer lithium secondary battery have a structure such that: a driving electrolyte is impregnated in an electrode body which comprises a positive electrode made by mixing an active material, a lithium-containing oxide, and a binder such as polyvinylidene fluoride with 1-methyl-2-pyrrolidone in the form of a sheet disposed on an aluminum collector, a negative electrode made by mixing a carbonaceous material that can absorb, store, and release lithium ions, and a binder such as polyvinylidene fluoride, with 1-methyl-2-pyrrolidone in the form of a sheet disposed on a copper collector, and a porous electrolyte membrane made of polyethylene, polypropylene, or the like, in which the positive electrode, the electrolyte membrane, and the negative electrode are wound or laminated in this order; and the electrode body is sealed in an aluminum case.

The electric double layer capacitor has a structure such that: a driving electrolyte is impregnated in an electrode body which has a kneaded material of an activated carbon, a conductant agent, and a binder, pasted on both sides of respective aluminum collectors of a positive electrode and a negative electrode, with these positive and negative collectors being wound or laminated via a separator made of cellulose or the like; the electrode body is packed in an aluminum case with a sealant; and the positive electrode lead and the negative electrode lead are piercing through the sealant and withdrawn to the outside so that short-circuiting would not occur.

The aluminum electrolytic capacitor has a structure such that: a driving electrolyte is impregnated in an electrode body which comprises an aluminum positive electrode foil that has been etched and then subjected to a chemical conversion treatment to form a dielectric coating membrane thereon, and an etched aluminum negative electrode foil, with the positive and negative electrodes being wound or laminated via a separator made of cellulose or the like; the electrode body is packed in an aluminum case with a sealant; and the positive electrode lead and the negative electrode lead are piercing through the sealant and withdrawn to the outside so that short-circuiting would not occur.

So far, as the separator for a lithium ion secondary battery and a polymer lithium secondary battery, porous membranes of polyethylene, polypropylene, and the like have been used. As the separator for an electric double layer capacitor and an aluminum electrolytic capacitor, a cellulose pulp paper and a cellulose fiber nonwoven fabric have been used.

Incidentally, electronic components as mentioned above are increasingly required to have higher and higher capacity and functions. In order to achieve higher capacity, the separator is required to be heat-resistant, mechanically strong, and dimensionally stable, enough to bear the heat of its own generated at the time of charging and discharging or abnormal heat generated when abnormal charging occurs. Meanwhile, as one of the means to achieve higher functions, an improved level of rapid charge and discharge characteristics, an improved level of high power characteristics, an improved level of utility under high temperature atmospheres, and the like are required, and the separator is strongly required to be a more thinned film, more homogenous and heat-resistant. However, conventional types of separators are not only insufficient in heat-resistance, but also, due to the form of a thin film, open holes are likely to be generated and also the mechanical strength is lowered. As a result, internal short-circuiting between electrodes is likely to occur, and the separator becomes so insufficiently homogenous that ionic migration may concentratedly occur in some local areas, leading to problems such as lowering of the reliability.

In addition, organic solvents and ionic solutions are used for the driving electrolyte of the lithium ion secondary battery and the electric double layer capacitor mentioned above. This leads to a problem in that, with a separator of cellulose or the like, the discharge capacity is lowered and deterioration involving a reduction of the film thickness may occur in a long term durability test at high temperatures.

The method for manufacturing these kinds of separators includes: a span bond method in which an olefin-based resin such as polyethylene or polypropylene is used as a material to make a dry nonwoven fabric or a woven fabric; and a wet sheet making method in which cellulose or the like is used as a material. Specifically, a wet production method has been proposed in which a fluid flow is applied to a fiber web formed of a segmented composite fiber having a fiber length of 3 to 25 mm (for example, refer to Patent Document 1). However, when a fluid flow is applied to a fiber web formed of a segmented composite fiber, the action to segment the fiber by ejection of a high pressure fluid makes open holes such as pinholes, which may cause internal short-circuiting between electrodes. In addition, another wet sheet making method has also been proposed in which a fibrillated high polymer and a fibrillated natural fiber are combined by mixture or lamination (for example, refer to Patent Document 2). However, such a fibrillated fiber tends to hold air on the fiber surface, and pinholes generated by foam that is held in the nonwoven fabric layer bring about defects such as internal short-circuiting between electrodes.

Moreover, the lithium ion secondary battery, the polymer lithium secondary battery, the electric double layer capacitor, and the aluminum electrolytic capacitor mentioned above use organic solvents or ionic solutions for the driving electrolyte. This leads to a problem in that, with a separator of cellulose or the like, severe deteriorations may occur in a long term durability test at high temperatures.

In response to such requirements for the separator, for example, what is proposed is the use of a microporous resin film (stretched film) having a relatively high value of air permeability produced by stretching a polyolefin and making open holes with a needle or a laser beam, as a separator (for example, refer to Patent Document 3). However, such a microporous resin film involves a concern in that, when used by itself, short-circuiting may occur between the positive electrode and the negative electrode because of the presence of open holes. Moreover, such a microporous resin film has a property to be shrinkable in a melt-down temperature range above the shutdown temperature, which as a result leads to a problem in that short-circuiting between electrodes becomes more likely to occur in cases of high temperatures. In addition, also proposed is the use of a separator including a chemical fiber which is less susceptible to heat deterioration in a driving electrolyte so as to thereby improve the heat-resistance and to elongate the service life for use at high temperatures (for example, refer to Patent Document 4). This document has a description saying that it is possible to use a chemical fiber at a blend ratio of about 10% of the separator with the balance of a cellulose fiber or the like. However, this separator is susceptible to deteriorations in the strength and the durability under high temperature environments in the presence of organic solvents or ionic solutions, because the mass of the separator decreases. Moreover, since a highly durable chemical fiber and a low durable cellulose fiber are randomly arranged in the sheet, the separator will be unevenly deteriorated by the organic solvent, which would easily cause current crowding. Furthermore, since the structure of the separator is a monolayer structure, internal short-circuiting is likely to occur when the separator is in the form of a thin film. In addition, in order to prevent internal short-circuiting, another document proposes to combine two or more layers into a single layer by lamination using a cylinder type paper machine (for example, refer to Patent Document 5). However, since the conventional separator has all the layers composed of natural fibers, the strength and the durability may be deteriorated under high temperature environments in the presence of organic solvents or ionic solutions, because the mass of the separator decreases. This leads to a problem in that the product characteristics can not be maintained. In addition, since single layers, each of which has been formed separately one by one by a cylinder type paper machine, are combined by lamination, boundaries are generated between layers, which may act as a cause to inhibit the ionic migration.

### Patent Documents

Patent Document 1: Japanese Unexamined Patent Application, First Publication No. H 8-273654
Patent Document 2: Japanese Unexamined Patent Application, First Publication No. 2003-168629
Patent Document 3: International Patent Publication WO 01/67536
Patent Document 4: Japanese Unexamined Patent Application, First Publication No. 2002-367863
Patent Document 5: Japanese Patent (Granted) Publication No. 2892412

The present invention provides a power storage device separator that is realized in the form of a heat-resistant, solvent-resistant, dimensionally stable thin film.

In prior art, no power storage device separator has been realized in the form of a thin film which can achieve higher quality such as higher capacity of the power storage device and higher reliability while using a polyelectrolyte.

Therefore, the present invention further provides a power storage device separator that can be realized in the form of a thin film which has excellent ion permeability and low resistance, which makes short-circuiting between electrodes and self-discharging difficult to occur, and in addition, which has excellent durability even after long periods of use under high temperature environments in the presence of organic solvents or ionic solutions.

### DISCLOSURE OF INVENTION

A power storage device separator as a first aspect of the present invention (hereunder, referred to as a “separator”) is characterized in that the separator includes at least a thermoplastic synthetic fiber A (hereunder, referred to as a “fiber A”), a heat-resistant synthetic fiber B (hereunder, referred to as a “fiber B”), and a natural fiber C (hereunder, referred to as a “fiber C”), and the fiber A comprises a polyester fiber of 50% or higher crystallinity.

A separator as a second aspect of the present invention is characterized in that the separator comprises a lamination of two or more fiber layers, and at least one of these fiber layers includes a polyester fiber of 50% or higher crystallinity.

That is, the present invention relates to the following items of (1) to (20).

(1) A separator for a power storage device, wherein the separator includes a thermoplastic synthetic fiber A, a heat-resistant synthetic fiber B, and a natural fiber C, and the thermoplastic synthetic fiber A comprises a polyester fiber of 50% or higher crystallinity.

(2) The separator for a power storage device according to (1), wherein the thermoplastic synthetic fiber A comprises at least one type of material selected from a polyethylene terephthalate, a polybutylene terephthalate, and a wholly aromatic polyalylate, of 50% or higher crystallinity.

(3) The separator for a power storage device according to either one of (1) and (2), wherein the heat-resistant synthetic fiber B comprises at least one type of material selected from a wholly aromatic polyamide, a wholly aromatic polyester, a semiaromatic polyamide, a polyphenylene sulfide, and a poly-p-phenylene benzobisoxazole.

(4) The separator for a power storage device according to any one of (1) through (3), wherein the blend ratio is such that the thermoplastic synthetic fiber A accounts for 25 to 50% by mass, the heat-resistant synthetic fiber B accounts for 60 to 10% by mass, and the natural fiber C accounts for 15 to 40% by mass.

(5) The separator for a power storage device according to any one of (1) through (4), wherein the thermoplastic synthetic fiber A has a fiber diameter of 5 μm or smaller and a fiber length of 10 mm or shorter.

(6) The separator for a power storage device according to any one of (1) through (5), wherein the heat-resistant synthetic fiber B is fibrillated to have a fiber diameter of 1 μm or smaller and a fiber length of 3 mm or shorter.

(7) The separator for a power storage device according to any one of (1) through (6), wherein the natural fiber C is a solvent-spinned cellulose that is fibrillated to have a fiber diameter of 1 μm or smaller and a fiber length of 3 mm or shorter.

(8) The separator for a power storage device according to any one of (1) through (7), wherein the separator comprises entangled fibers of a thermally fused thermoplastic synthetic fiber A, a fibrillated heat-resistant synthetic fiber B and/or a fibrillated natural fiber C.

(9) The separator for a power storage device according to any one of (1) through (8), wherein the separator has a film thickness of 60 μm or thinner.

(10) The separator for a power storage device according to any one of (1) through (9), wherein the separator has a density from 0.2 to 0.7 g/cm³.

(11) The separator for a power storage device according to any one of (1) through (10), wherein the separator has an air permeability of 100 seconds/100 ml or lower.

(12) The separator for a power storage device according to any one of (1) through (11), wherein the power storage device is a lithium ion secondary battery, a lithium ion capacitor, a polymer battery, or an electric double layer capacitor.

(13) A separator for a power storage device, wherein the separator comprises a lamination of two or more fiber layers, and at least one of these fiber layers includes a polyester fiber of 50% or higher crystallinity.

(14) The separator for a power storage device according to (13), wherein the fiber layer including the polyester fiber of 50% or higher crystallinity also contains another type of synthetic fiber.

(15) The separator for a power storage device according to either one of (13) and (14), wherein the polyester fiber is at least one type of material selected from a polyethylene terephthalate, a polybutylene terephthalate, and a wholly aromatic polyalylate, of 50% or higher crystallinity.

(16) The separator for a power storage device according to any one of (13) through (15), wherein the polyester fiber and the synthetic fiber have fiber diameters of 5 μm or smaller and fiber lengths of 10 mm or shorter.

(17) The separator for a power storage device according to any one of (14) through (16), wherein the synthetic fiber is at least one type of material selected from a wholly aromatic polyamide, a wholly aromatic polyester, a semiaromatic polyamide, a polyphenylene sulfide, a poly-p-phenylene benzobisoxazole, a polyethylene, and a polypropylene.

(18) The separator for a power storage device according to any one of (13) through (17), wherein the fiber layer is made by combining layers by lamination on a papermaking net with use of an inclined wire type paper machine having two or more heads.

(19) The separator for a power storage device according to any one of (13) through (17), wherein the fiber layer is made by combining layers by lamination on a papermaking net with use of a multi-tank inclined type wet paper machine that is capable of forming a plurality of layers at the same time with a structure such that a lower part of a second flow box is positioned in a vicinity of a crossing part between the waterline in a first flow box and the papermaking net.

(20) The separator for a power storage device according to any one of (13) through (19), wherein the power storage device is any one of a lithium ion secondary battery, a polymer lithium secondary battery, an electric double layer capacitor, and an aluminum electrolytic capacitor.

The power storage device separator of the first aspect of the present invention is a thin film having quite excellent durability for long periods of use under high temperature environments in the presence of organic solvents or ionic solutions, can be suitably used for power storage devices such as an electric double layer capacitor, and excels in the prevention against short-circuiting between electrodes and the suppression on self-discharging. Moreover, this separator is excellently heat-resistant and solvent-resistant, and stable for long periods of use at high temperatures.

In addition, the separator of the second aspect of the present invention can be realized in the form of a thin film which has excellent ion permeability and low resistance, which excels in the prevention against short-circuiting between electrodes and the suppression on self-discharging, and in addition, which has excellent durability after long periods of use at high temperatures in the presence of organic solvents or ionic solutions.

Accordingly, the separator of the present invention can be suitably used for power storage devices, in particular for a lithium ion secondary battery, a polymer lithium secondary battery, an electric double layer capacitor, and an aluminum electrolytic capacitor.

### BRIEF DESCRIPTION OF THE DRAWINGS

FIG. 1 is a cross-sectional view showing the structure of a multi-tank inclined type wet paper machine according to the present invention.

### DESCRIPTION OF EMBODIMENTS

The fiber A for use in the separator of a first aspect of the present invention preferably comprises a resin selected from polyester fibers such as a polyethylene terephthalate, a polybutylene terephthalate, or a wholly aromatic polyalylate, of 50% or higher crystallinity. By having the fiber A of 50% or higher crystallinity, the durability against organic solvents, ionic solutions, and in addition, high temperature conditions, can be improved, which makes it possible to provide a separator that hardly deteriorates even if continuously used for a long period of time under a high temperature atmosphere.

The fiber B may be at least one type of material selected from a wholly aromatic polyamide, a wholly aromatic polyester, a semiaromatic polyamide, a polyphenylene sulfide, and a poly-p-phenylene benzobisoxazole. It is also possible to use two or more types of materials. These materials are not soluble with organic solvents or ionic solutions used for the driving electrolyte, and can be fibrillated into fine fibers.

By including the fiber B in the separator, the durability against organic solvents, ionic solutions, and in addition, high temperature conditions, can be improved, which makes the separator difficult to deteriorate even if continuously used for a long period of time under a high temperature atmosphere. Moreover, the use of fibrillated fiber B makes pinholes difficult to occur, by which the separator will have excellent prevention against short-circuiting.

For the fiber C constituting the present invention, it is possible to use, for example, cotton, flax, kenaf, banana, pineapple, sheep wool, silk, angora wool, cashmir wool, rayon, cupra, polynosic, solvent-spinned cellulose, or the like. It is either possible to use one type or more types of materials to constitute the fiber C. The separator using such materials will have better ability to impregnate the electrolyte. In the present invention, it is preferable to use fibrillated fine fiber as the fiber C, and it is particularly preferable to use fibrillated solvent-spinned cellulose. The fibrillated solvent-spinned cellulose has excellent ability to impregnate the electrolyte, and can sufficiently tangle with fibers. Thus, the separator will have excellent mechanical strength.

In the present invention, it is preferable that the fiber A has a fiber diameter of 5 μm or smaller and a fiber length of 10 mm or shorter, and particularly preferred are a fiber diameter of 3 μm or smaller and a fiber length of 7 mm or shorter. With a fiber diameter smaller than 5 μm and a fiber length longer than 10 mm, open holes will be more likely to be generated when a thin film is formed, which may serve as a cause to induce internal short-circuiting. Moreover, the crystallinity of the fiber A is to be 50% or higher, and particularly preferably 70% or higher. If the crystallinity is lower than 50%, the fiber A will be easily dissolved with organic solvents or ionic solutions, which may serve as a cause to induce deterioration when used for a long period of time under a high temperature atmosphere.

The crystallinity of the polyester fiber can be determined by measuring the endothermic peak derived from crystallization through DSC (differential scanning calorimeter). Moreover, the crystallinity can be measured by obtaining the correlation between the peak band that shows different crystallinity and the density through FT Raman spectroscopy.

In the present invention, it is preferable that the fibrillated fiber B has a fiber diameter of 1 μm or smaller and a fiber length of 3 mm or shorter, and particularly preferred is a fiber length of 1 mm or shorter. With a fiber diameter larger than 1 μm and a fiber length longer than 3 mm, open holes will be more likely to be generated when a thin film is formed, which may serve as a cause to induce internal short-circuiting, and entanglement of the fibers will be weakened. Thus, the mechanical strength is apt to be weakened.

In the present invention, it is preferable that the fibrillated fiber C has a fiber diameter of 1 μm or smaller and a fiber length of 3 mm or shorter, and particularly preferred is a fiber length of 1 mm or shorter. With a fiber diameter larger than 1 μm and a fiber length longer than 3 mm, open holes will be more likely to be generated when a thin film is formed, which may serve as a cause to induce internal short-circuiting, and entanglement of the fibers will be weakened. Thus, the mechanical strength is apt to be weakened, and sufficient ability to impregnate the electrolyte becomes hard to achieve.

In the present invention, the preferred blend ratio of the fiber A, the fiber B, and the fiber C in all the fibers is as follows. That is, it is preferable to mix the fiber A within a range from 25 to 50% by mass in all the fibers constituting the separator. If the fiber A accounts for less than 25% by mass, the anti-crush effect (spacer effect) of the separator in the Z-axis direction can not work sufficiently and thus short-circuiting due to compression will be more likely to occur. If the fiber A accounts for more than 50% by mass, the porosity may decrease and pores may be clogged, which leads to an increase in the internal resistance. Moreover, because the fiber A is thermoplastic, the separator may become unstable at high temperatures, in which case the durability will be lowered. Furthermore, because the amount of the fibrillated fine fibers falls under 50% by mass in the separator, the pore size of the separator becomes uncontrollable and thus internal short-circuiting will be more likely to occur.

In addition, it is preferable to mix the fiber B within a range from 60 to 10% by mass in all the fibers constituting the separator. If the fiber B accounts for less than 10% by mass, the amount of the fibrillated fine fibers is so insufficient that the pore size of the separator becomes uncontrollable and thus internal short-circuiting will be more likely to occur. If the fiber B accounts for more than 60% by mass, the amount of the fibrillated fine fibers is so large that the separator becomes too dense, which as a result leads to an increase of the internal resistance.

Furthermore, it is preferable to mix the fiber C within a range from 15 to 40% by mass in all the fibers constituting the separator. If the fiber C accounts for less than 15% by mass, the entanglement of fibers will be weakened. Thus, the mechanical strength is apt to be weakened, and sufficient ability to impregnate the electrolyte becomes hard to achieve. If the fiber C accounts for more than 40% by mass, the durability is likely to be lowered by organic solvents or ionic solutions under high temperature atmospheric conditions.

In the present invention, the average pore size of the fiber layer is preferably from 0.1 μm to 15 μm, and more preferably within a range from 0.1 μm to 5.0 μm, when measured by a bubble point method. If the average pore size is smaller than 0.1 μm, the ionic conductivity is lowered and the internal resistance is prone to increase. In addition, it becomes difficult to drain water in the production of the separator. Therefore, the production becomes difficult to carry out. If the average pore size is greater than 15 μm, internal short-circuiting will be more likely to occur in cases where a thin film is formed. For the measurement of the pore size by means of the bubble point method, a porometer manufactured by Seika Corporation can be used.

Even though the separator of the first aspect of the present invention has sufficient tensile strength and sufficient compressive strength, it is possible to further improve the strengths by mixing a binder resin or a binder fiber therein. The binder resin or the binder fiber can be exemplified by various substances such as, but not limited to, polyvinyl alcohol, polyacrylonitrile, polyethylene, and derivatives thereof.

The film thickness of the separator of the first aspect of the present invention is preferably 60 μm or thinner. If the film thickness of the separator is over 60 μm, it is a disadvantage for the power storage device to be in the form of a thin film, and at the same time the amount of the electrode material that can be put in a certain volume of cell decreases, meaning that not only the capacity decreases but also the resistance increases. Therefore, such a large thickness is not preferred.

Moreover, the density of the separator of the first aspect of the present invention is preferably from 0.20 g/cm³ to 0.70 g/cm³, more preferably from 0.25 g/cm³ to 0.65 g/cm³, and particularly preferably from 0.30 g/cm³ to 0.60 g/cm³. If the density is below 0.20 g/cm³, too much space in the separator is occupied by void, which is likely to cause short-circuiting, worsening of the property to prevent self-discharging, and such failures. On the other hand, if the density is over 0.70 g/cm³, the materials constituting the separator are so densely packed that the ionic migration may be inhibited and the resistance is likely to increase.

The air permeability of the separator of the first aspect of the present invention is preferably 100 seconds/100 ml or lower. With such a level of air permeability, the ionic conductivity can be favorably maintained. The air permeability of the separator of the present invention means a value measured by a Gurley air permeability tester.

As described above, the separator of the first aspect of the present invention includes the fiber A, the fiber B, and the fiber C, and the fiber A comprises a polyester fiber of 50% or higher crystallinity. Therefore, the separator is hardly deteriorated by organic solvents or ionic solutions even if placed under a high temperature atmosphere, and can be suitably used for power storage devices such as a lithium ion secondary battery, a lithium ion capacitor, a polymer battery, and an electric double layer capacitor. In addition, when a power storage device is produced by using the separator of the present invention, the materials to constitute the electrochemical elements such as the positive electrode, the negative electrode, and the electrolyte may be any conventionally known ones.

Next is a description of the method for producing the separator of the first aspect of the present invention. However, the present invention is not to be limited thereto, and it is also possible to produce the separator of the present invention by other methods. First, one or more types of fiber(s) A cut or beaten to have a fiber diameter of 5 μm or smaller and a fiber length of 10 mm or shorter, a fiber B fibrillated to have a fiber diameter of 1 μm or smaller and a fiber length of 3 mm or shorter, and a fiber C fibrillated to have a fiber diameter of 1 μm or smaller and a fiber length of 3 mm or shorter are dispersed in water. The order to put these fibers into water is not determined. The fiber for use in the present invention is too fine to be homogenously dispersed in the defibration step. Thus, it is possible to use a dispersing machine such as a pulper and an agitator, or an ultrasonic dispersing machine, to enable a satisfactory level of dispersion. In addition, regarding the water for use in this dispersion step, it is preferable to use ion-exchanged water so as to reduce ionic impurities as much as possible. Next, either the same synthetic fiber as the above-mentioned fiber, or a different type of fiber, is dispersed in water by using another dispersing machine such as a pulper or an agitator differing from the above-mentioned machine. Beating can be conducted by using a typical beating machine including a ball mill, a beater, a Lampen mill, a PFI mill, a SDR (single disk refiner), a DDR (double disk refiner), a high pressure homogenizer, a homo mixer, or any other refiner.

The thus obtained fiber dispersion is formed into a sheet by using a wet-type paper machine such as those of a fourdrinier type, a tanmo type, a cylinder type, and an inclined type. The sheet is then dewatered in a dewatering part in the form of a continuous wire mesh. By using an inclined wire type paper machine having two heads among the wet-type paper machines, it becomes possible, in cases where two or more fiber layers are combined by lamination, to obtain a homogenous separator without pinholes where boundaries are less likely to be generated between the laminated fiber layers. After combining the fiber layers, the sheet is subjected to a dryer part such as a multi-cylinder type dryer and a Yankee type dryer. By so doing, the separator of the first aspect of the present invention can be obtained.

By subjecting the sheet to the above-mentioned dryer part, the fiber A becomes so the many adhesive that the fiber A can tangle with the fibrillated fiber B and/or the fibrillated fiber C. By so doing, the separator having excellent mechanical strength can be provided.

At least one layer of the separator of the second aspect of the present invention includes a polyester fiber of 50% or higher crystallinity. The polyester fiber of 50% or higher crystallinity preferably comprises at least one type of resin selected from polyester fibers such as a polyethylene terephthalate, a polybutylene terephthalate, and a wholly aromatic polyalylate. By having a polyester fiber of 50% or higher crystallinity, the durability against organic solvents, ionic solutions, and in addition, high temperature conditions, can be improved, which makes it possible to provide a separator that hardly deteriorates even if continuously used for a long period of time under a high temperature atmosphere. The crystallinity of the polyester fiber is 50% or higher, and particularly preferably 70% or higher. If the crystallinity is lower than 50%, the polyester fiber will be easily dissolved with organic solvents or ionic solutions, which may serve as a cause to induce deterioration when used for a long period of time under a high temperature atmosphere.

The crystallinity of the polyester fiber can be determined by measuring the endothermic peak derived from crystallization through DSC (differential scanning calorimeter). Moreover, the crystallinity can be measured by obtaining the correlation between the peak band that shows different crystallinity and the density through FT Raman spectroscopy.

Besides the above-mentioned polyester fiber, another type of synthetic fiber may also be included. Such another type of synthetic fiber preferably comprises, but is not limited to, at least one type of material selected from a wholly aromatic polyamide, a wholly aromatic polyester, a semiaromatic polyamide, a polyphenylene sulfide, a poly-p-phenylene benzobisoxazole, a polyethylene, and a polypropylene. It is possible to use highly heat-resistant materials which are not soluble with organic solvents or ionic solutions used for the driving electrolyte. By laminating a fiber layer including such a synthetic fiber, the durability against organic solvents and ionic solutions can be improved, which makes the separator difficult to deteriorate even if continuously used for a long period of time under a high temperature atmosphere.

The polyester fiber and the another type of synthetic fiber preferably have fiber diameters of 5 μm or smaller and fiber lengths of 10 mm or shorter. Particularly preferred are fiber diameters of 3 μm or smaller and fiber lengths of 3 mm or shorter. If the fiber diameters are larger than 5 μm and the fiber lengths are longer than 10 mm, open holes will be more likely to be generated when a thin film is formed, which may serve as a cause to induce internal short-circuiting.

In the present invention, the fibers for use in the fiber layer including the polyester fiber and the fiber layer to be disposed on the fiber layer can be selected from the above-mentioned synthetic fibers, or any other synthetic fiber, a cellulose fiber made of natural pulp, or the like may be used. Preferably, these synthetic fiber, cellulose fiber, or the like are beatable so as to improve the property to hold the electrolyte and so as to form a homogenous fiber layer.

In the separator of the second aspect of the present invention, the average pore size of the fiber layer is preferably from 0.1 μm to 15 μm, and more preferably within a range from 0.1 μm to 5.0 μm, when measured by a bubble point method. If the average pore size is smaller than 0.1 μm, the ionic conductivity is lowered and the internal resistance is prone to increase. In addition, it becomes difficult to drain water in the production of the separator. Therefore, the production becomes difficult to carry out. If the average pore size is greater than 15 μm, internal short-circuiting will be more likely to occur in cases where a thin film is formed. For the measurement of the pore size by means of the bubble point method, a porometer manufactured by Seika Corporation can be used.

Even though the separator of the second aspect of the present invention has sufficient tensile strength and sufficient compressive strength, it is possible to further improve the strengths by mixing a binder resin or a binder fiber therein. The binder resin or the binder fiber can be exemplified by various substances such as, but not limited to, polyvinyl alcohol, polyacrylonitrile, polyethylene, and derivatives thereof.

The thickness of the separator of the second aspect of the present invention is preferably 50 μm or thinner. If the thickness of the separator is over 50 μm, it is a disadvantage for the power storage device to be in the form of a thin film, and at the same time the amount of the electrode material that can be put in a certain volume of cell decreases, meaning that not only the capacity decreases but also the resistance increases. Therefore, such a large thickness is not preferred.

Moreover, the density of the separator of the second aspect of the present invention is preferably from 0.20 g/cm³ to 0.75 g/cm³. If the density is below 0.20 g/cm³, too much space in the separator is occupied by void, which is likely to cause short-circuiting, worsening of the property to prevent self-discharging, and such failures. On the other hand, if the density is over 0.75 g/cm³, the materials constituting the separator are so densely packed that the ionic migration may be inhibited and the resistance is likely to increase.

The porosity of the separator of the second aspect of the present invention is preferably within a range from 30% to 90% so as to achieve both the prevention of short-circuiting and the suppression of an increase in the resistance.

The porosity used herein can be obtained from the following equation with use of the grammage M (g/m²), the thickness T (μm), and the true density D (g/cm³).

Porosity (%)=[1−(M/T)/D]×100

Next is a description of the method for producing the separator of the second aspect of the present invention. However, the present invention is not to be limited thereto, and it is also possible to produce the separator of the present invention by other methods. First, one or more types of polyester fiber(s) of 50% or higher crystallinity cut or beaten to have a fiber diameter of 5 μm or smaller and a fiber length of 10 mm or shorter is/are dispersed in water. The fiber(s) for use in the present invention is/are too fine to be homogenously dispersed in the defibration step. Thus, it is possible to use a dispersing machine such as a pulper and an agitator, or an ultrasonic dispersing machine, to enable a satisfactory level of dispersion. In addition, regarding the water for use in this dispersion step, it is preferable to use ion-exchanged water, and particularly preferable to use pure water, so as to reduce ionic impurities as much as possible.

Next, either the same synthetic fiber as the above-mentioned fiber, or a different type of fiber, is dispersed in water by using another dispersing machine such as a pulper or an agitator differing from the above-mentioned machine. Beating can be conducted by using a typical beating machine including a ball mill, a beater, a Lampen mill, a PFI mill, a SDR (single disk refiner), a DDR (double disk refiner), a high pressure homogenizer, a homo mixer, or any other refiner.

The thus obtained fiber dispersion (slurry) is formed into a sheet by using a wet-type paper machine such as those of a fourdrinier type, a tanmo type, a cylinder type, and an inclined type. Next, the sheet is dewatered in a dewatering part in the form of a continuous wire mesh, and then subjected to a dryer part such as a multi-cylinder type dryer and a Yankee type dryer. By so doing, the separator of the second aspect of the present invention can be obtained. Regarding the paper machine, it is preferable to use an inclined wire type paper machine having two heads so as to combine fiber layers by lamination on a papermaking net, because fiber layers can be kept from separating from each other.

In particular, it is more preferable to use a multi-tank inclined type wet paper machine that is capable of forming a plurality of layers at the same time with a structure such that a lower part of a second flow box is positioned in a vicinity of the crossing part between the waterline in a first flow box and a papermaking net, so as to make a separator comprising a combination of fiber layers laminated on the papermaking net, because fibers can tangle with each other between the laminated fiber layers, making the fiber layers difficult to separate from each other. Moreover, the separator obtained by such a multi-tank inclined type wet paper machine will be a homogenous separator without pinholes where boundaries are less likely to be generated between the fiber layers.

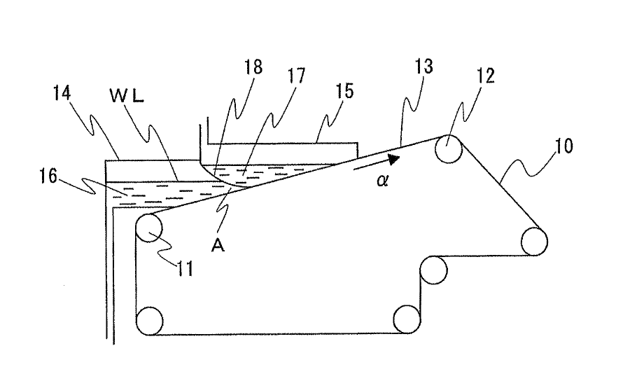

This kind of multi-tank inclined type wet paper machine has a structure shown in FIG. 1. As shown in FIG. 1, the papermaking net 10 travels in the arrow a direction by a plurality of guide rollers. A part of the papermaking net 10 inclined between the guide roller 11 and the guide roller 12 is referred to as an inclined traveling part 13. In the present invention, a lower part of the second flow box 15 is positioned in a vicinity A of the crossing part between the waterline WL in the first flow box 14 and the inclined traveling part 13. In the vicinity A of the crossing part, a fiber-containing dispersion 16 in the first flow box 14 and a fiber-containing dispersion 17 in the second flow box 15 are next to each other across the partition 18. There is a space between the partition 18 and the inclined traveling part 13 in the vicinity A of the crossing part so that the dispersion 16 which is flowing out from the first flow box 14 along with the travel of the papermaking net 10 can pass through this space to thereby be mixed with the dispersion 17 in the second flow box 15.

The separator of the second aspect of the present invention is a laminated body in which two or more fiber layers are laminated. At least one of these layers includes a polyester fiber of 50% or higher crystallinity. In the present invention, by having a laminated body of two or more fiber layers, pinholes hardly occur, and accordingly the separator can have an excellent prevention effect against short-circuiting. Moreover, by including a polyester fiber of 50% or higher crystallinity, the durability against organic solvents, ionic solutions, and in addition, high temperature conditions, can be improved, and thus the separator can have an excellent effect against deterioration in a long period of time under a high temperature atmosphere. In addition, the separator is hardly deteriorated by organic solvents or ionic solutions under a high temperature atmosphere, and can be suitably used for power storage devices such as a lithium ion secondary battery, a polymer lithium secondary battery, an electric double layer capacitor, and an aluminum electrolytic capacitor. In addition, when a power storage device is produced by using the separator of the present invention, the materials to constitute the power storage devices such as the positive electrode, the negative electrode, and the electrolyte may be any conventionally known ones.

### Example 1

A fiber A comprising a polyethylene terephthalate fiber of 55% crystallinity having a fiber diameter of 2.5 μm and a fiber length of 6 mm, a fiber B comprising a wholly aromatic polyamide fibrillated to have a fiber diameter of 0.2 μm and a fiber length of 0.6 mm, and a fiber C comprising a solvent-spinned cellulose fibrillated to have a fiber diameter of 0.5 μm and a fiber length of 1 mm, at a mass ratio of 25:60:15, were respectively charged into ion-exchanged water to have a concentration of 0.05% by mass in a pulper. This mixture was dispersed for 30 minutes. By so doing, a paper material made of the fiber dispersion was produced.

The paper material was formed into a wet sheet by using a standard handsheet machine as defined in JIS P8222. Thereafter, the thus produced wet sheet was taken out from the handsheet machine and then dried at 130° C. by a Yankee type dryer, thereby producing a separator of the present invention. Regarding the physical properties of the produced separator, the film thickness of the separator was 31 μm, the density was 0.41 g/cm³, and the air permeability was 8 seconds/100 ml.

### Example 2

A fiber A comprising a polyethylene terephthalate fiber of 73% crystallinity having a fiber diameter of 2.5 μm and a fiber length of 6 mm, a fiber B comprising a wholly aromatic polyamide fibrillated to have a fiber diameter of 0.2 μm and a fiber length of 0.6 mm, and a fiber C comprising a solvent-spinned cellulose fibrillated to have a fiber diameter of 0.5 μm and a fiber length of 1 mm, at a mass ratio of 25:60:15, were respectively charged into ion-exchanged water to have a concentration of 0.05% by mass in a pulper. This mixture was dispersed for 30 minutes. By so doing, a paper material made of the fiber dispersion was produced.

The paper material was formed into a wet sheet by using a standard handsheet machine as defined in JIS P8222. Thereafter, the thus produced wet sheet was taken out from the handsheet machine and then dried at 130° C. by a Yankee type dryer, thereby producing a separator of the present invention. Regarding the physical properties of the produced separator, the film thickness of the separator was 30 μm, the density was 0.41 g/cm³, and the air permeability was 8 seconds/100 ml.

### Example 3

A fiber A comprising a polyethylene terephthalate fiber of 55% crystallinity having a fiber diameter of 3.2 μm and a fiber length of 6 mm, a fiber B comprising a wholly aromatic polyamide fibrillated to have a fiber diameter of 0.2 μm and a fiber length of 0.6 mm, and a fiber C comprising a solvent-spinned cellulose fibrillated to have a fiber diameter of 0.5 μm and a fiber length of 1 mm, at a mass ratio of 40:40:20, were respectively charged into ion-exchanged water to have a concentration of 0.05% by mass in a pulper. This mixture was dispersed for 30 minutes. By so doing, a paper material made of the fiber dispersion was produced. Thereafter, a separator of the present invention was produced in the same manner as that of Example 1. Regarding the physical properties of the produced separator, the film thickness of the separator was 49 μm, the density was 0.32 g/cm³, and the air permeability was 15 seconds/100 ml.

### Example 4

A fiber A comprising a polyethylene terephthalate fiber of 55% crystallinity having a fiber diameter of 2.5 μm and a fiber length of 6 mm, a fiber B comprising a polyphenylene sulfide fibrillated to have a fiber diameter of 0.8 μm and a fiber length of 1.5 mm, and a fiber C comprising a solvent-spinned cellulose fibrillated to have a fiber diameter of 0.5 μm and a fiber length of 1 mm, at a mass ratio of 30:30:40, were respectively charged into ion-exchanged water to have a concentration of 0.05% by mass in a pulper. This mixture was dispersed for 30 minutes. By so doing, a paper material made of the fiber dispersion was produced. Thereafter, a separator of the present invention was produced in the same manner as that of Example 1. Regarding the physical properties of the produced separator, the film thickness of the separator was 22 μm, the density was 0.45 g/cm³, and the air permeability was 5 seconds/100 ml.

### Example 5

A fiber A comprising a polybutylene terephthalate fiber of 55% crystallinity having a fiber diameter of 3 μm and a fiber length of 6 mm, a fiber B comprising a wholly aromatic polyamide fibrillated to have a fiber diameter of 0.2 μm and a fiber length of 0.6 mm, and a fiber C comprising a solvent-spinned cellulose fibrillated to have a fiber diameter of 0.5 μm and a fiber length of 1 mm, at a mass ratio of 50:30:20, were respectively charged into ion-exchanged water to have a concentration of 0.05% by mass in a pulper. This mixture was dispersed for 30 minutes. By so doing, a paper material made of the fiber dispersion was produced. Thereafter, a separator of the present invention was produced in the same manner as that of Example 1. Regarding the physical properties of the produced separator, the film thickness of the separator was 57 μm, the density was 0.36 g/cm³, and the air permeability was 19 seconds/100 ml.

### Example 6

A fiber A comprising a wholly aromatic polyalylate fiber of 55% crystallinity having a fiber diameter of 3 μm and a fiber length of 6 mm, a fiber B comprising a wholly aromatic polyester fibrillated to have a fiber diameter of 0.4 μm and a fiber length of 1 mm, and a fiber C comprising a solvent-spinned cellulose fibrillated to have a fiber diameter of 0.5 μm and a fiber length of 1 mm, at a mass ratio of 25:60:15, were respectively charged into ion-exchanged water to have a concentration of 0.05% by mass in a pulper. This mixture was dispersed for 30 minutes. By so doing, a paper material made of the fiber dispersion was produced. Thereafter, a separator of the present invention was produced in the same manner as that of Example 1. Regarding the physical properties of the produced separator, the film thickness of the separator was 32 μm, the density was 0.45 g/cm³, and the air permeability was 11 seconds/100 ml.

### Example 7

A fiber A comprising a polyethylene terephthalate fiber of 55% crystallinity having a fiber diameter of 2.5 μm and a fiber length of 6 mm, a fiber B comprising a poly-p-phenylene benzobisoxazole fibrillated to have a fiber diameter of 0.3 μm and a fiber length of 1 mm, and a fiber C comprising a solvent-spinned cellulose fibrillated to have a fiber diameter of 0.5 μm and a fiber length of 1 mm, at a mass ratio of 25:50:25, were respectively charged into ion-exchanged water to have a concentration of 0.05% by mass in a pulper. This mixture was dispersed for 30 minutes. By so doing, a paper material made of the fiber dispersion was produced. Thereafter, a separator of the present invention was produced in the same manner as that of Example 1. Regarding the physical properties of the produced separator, the film thickness of the separator was 38 μm, the density was 0.62 g/cm³, and the air permeability was 42 seconds/100 ml.

### Comparative Example 1

A fiber A comprising a polyethylene terephthalate fiber of 20% crystallinity having a fiber diameter of 2.5 μm and a fiber length of 6 mm, a fiber B comprising a wholly aromatic polyamide fibrillated to have a fiber diameter of 0.2 μm and a fiber length of 0.6 mm, and a fiber C comprising a solvent-spinned cellulose fibrillated to have a fiber diameter of 0.5 μm and a fiber length of 1 mm, at a mass ratio of 25:60:15, were respectively charged into ion-exchanged water to have a concentration of 0.05% by mass in a pulper. This mixture was dispersed for 30 minutes. By so doing, a paper material made of the fiber dispersion was produced.

The paper material was formed into a wet sheet by using a standard handsheet machine as defined in JIS P8222. Thereafter, the thus produced wet sheet was taken out from the handsheet machine and then dried at 130° C. by a Yankee type dryer, thereby producing a separator of this comparative example. Regarding the physical properties of the produced separator, the film thickness of the separator was 30 μm, the density was 0.41 g/cm³, and the air permeability was 8 seconds/100 ml.

### Comparative Example 2

A fiber C comprising a solvent-spinned cellulose fibrillated to have a fiber diameter of 0.5 μm and a fiber length of 1 mm was charged into ion-exchanged water to have a concentration of 0.05% by mass in a pulper. This mixture was dispersed for 30 minutes. By so doing, a paper material made of the dispersion of the fiber C alone without including the fiber A and the fiber B was produced. Thereafter, a comparative separator was produced in the same manner as that of Example 1. Regarding the physical properties of the produced separator, the film thickness of the separator was 35 μm, the density was 0.41 g/cm³, and the air permeability was 5 seconds/100 ml.

### Comparative Example 3

A fiber A comprising a polyethylene terephthalate fiber of 55% crystallinity having a fiber diameter of 2.5 μm and a fiber length of 6 mm, and a fiber C comprising a solvent-spinned cellulose fibrillated to have a fiber diameter of 0.5 μm and a fiber length of 1 mm, at a mass ratio of 80:20, were respectively charged into ion-exchanged water to have a concentration of 0.05% by mass in a pulper. This mixture was dispersed for 30 minutes. By so doing, a paper material made of the dispersion of the fiber A and the fiber C without including the fiber B was produced. Thereafter, a comparative separator was produced in the same manner as that of Example 1. Regarding the physical properties of the produced separator, the film thickness of the separator was 70 μm, the density was 0.32 g/cm³, and the air permeability was 39 seconds/100 ml.

### Comparative Example 4

A polyethylene fiber of 55% crystallinity having a fiber diameter of 3 μm and a fiber length of 6 mm, and a fiber C comprising a solvent-spinned cellulose fibrillated to have a fiber diameter of 0.4 μm and a fiber length of 1 mm, at a mass ratio of 30:70, were respectively charged into ion-exchanged water to have a concentration of 0.05% by mass in a pulper. This mixture was dispersed for 30 minutes. By so doing, a paper material made of the dispersion of the polyethylene fiber and the fiber C without including the fiber B was produced. Thereafter, a comparative separator was produced in the same manner as that of Example 1. Regarding the physical properties of the produced separator, the film thickness of the separator was 51 μm, the density was 0.72 g/cm³, and the air permeability was 104 seconds/100 ml.

The separators produced by the Examples 1 to 7 and the Comparative Examples 1 to 4 were evaluated in the following manner so as to make an evaluation of the quality as a separator for a power storage device. The values of the physical properties of the respective separators, namely, the blend ratio of fibers, the film thickness, the density, and the air permeability, are shown in Table 1.

TABLE 1

| | Blend ratio | | | | | Air |
|---|---|---|---|---|---|---|
| | (% by mass) | | | Film | | permeability |
| | Fiber | Fiber | | thickness | Density | (seconds/ |
| | A | B | Fiber C | (μm) | (g/cm³) | 100 ml) |
| Example 1 | 25 | 60 | 15 | 31 | 0.41 | 8 |
| Example 2 | 25 | 60 | 15 | 30 | 0.41 | 8 |
| Example 3 | 40 | 40 | 20 | 49 | 0.32 | 15 |
| Example 4 | 30 | 30 | 40 | 22 | 0.45 | 5 |
| Example 5 | 50 | 30 | 20 | 57 | 0.36 | 19 |
| Example 6 | 25 | 60 | 15 | 32 | 0.45 | 11 |
| Example 7 | 25 | 50 | 25 | 38 | 0.62 | 42 |
| Comparative | 25 | 60 | 15 | 30 | 0.41 | 8 |
| Example 1 | | | | | | |
| Comparative | — | — | 100 | 35 | 0.41 | 5 |
| Example 2 | | | | | | |
| Comparative | 80 | — | 20 | 70 | 0.32 | 39 |
| Example 3 | | | | | | |
| Comparative | 30 | — | 70 | 51 | 0.72 | 104 |
| Example 4 | | | | | | |

### Assembling of Electric Double Layer Capacitors and Evaluation of the Change in Discharge Capacity During Long-Term High Temperature Test

Electric double layer capacitors were assembled using the separators of Examples 1 to 7 and Comparative Examples 1 to 4 with a positive electrode and a negative electrode. One hundred coiled cells were produced per each type of separator. In the production of the coiled cell, activated carbon electrodes for use in electric double layer capacitors (manufactured by Hosen Co., Ltd) were used as the electrodes. In addition, a propylene carbonate solution having 1 mol/L tetraethylammonium tetrafluoroborate (manufactured by Kishida Chemical Co., Ltd.) dissolved therein was used as the electrolyte.

The produced coiled cell was subjected to an evaluation of the change (reduction) in the discharge capacity after a long-term high temperature test, by measuring the discharge capacity with an LCR meter, at the time of initiation, after 2000 hours, and after 4000 hours, of the test. The test was carried out under a condition of 80° C. with an application of 2.5 V.

The obtained results are shown in Table 2.

TABLE 2

| | Discharge capacity (F) | | |
|---|---|---|---|
| | At initiation | After 2000 hours | After 4000 hours |
| Example 1 | 9.8 | 9.5 | 9.2 |
| Example 2 | 10.5 | 10.4 | 10.1 |
| Example 3 | 10.2 | 9.8 | 9.2 |
| Example 4 | 9.9 | 9.4 | 8.9 |
| Example 5 | 10.0 | 9.5 | 9.0 |
| Example 6 | 10.1 | 9.9 | 9.7 |
| Example 7 | 10.4 | 10.1 | 9.7 |
| Comparative | 9.9 | 9.0 | 8.1 |
| Example 1 | | | |
| Comparative | 10.0 | 8.8 | 7.5 |
| Example 2 | | | |
| Comparative | 10.2 | 9.2 | Internal short- |
| Example 3 | | | circuiting |
| Comparative | 9.8 | 8.8 | 4.5 |
| Example 4 | | | |

As is apparent from the results of Table 2, it was confirmed that the electric double layer capacitors using the separators of the present invention maintained sufficient discharge capacity at 8.9 F or higher, showing excellent durability, even after 4000 hours of 2.5 V voltage application at 80° C. In contrast, the electric double layer capacitors using the separators of the Comparative Examples 1 to 4 showed a remarkably large reduction in the discharge capacity, and sometimes internal short-circuiting occurred, meaning quite inferior properties.

Comparison of Separator Film Thickness after 4000 Hours of Long-Term High Temperature Test

After the completion of the above-mentioned long-term high temperature test for 4000 hours, each electric double layer capacitor was disassembled. The separator was taken out from the element, washed with methanol, and dried. Then, the film thickness of the separator was measured. The obtained results are shown in Table 3.

TABLE 3

| | Film thickness (μm) | |
|---|---|---|
| | At initiation | After 4000 hours |
| Example 1 | 31 | 31 |
| Example 2 | 30 | 29 |
| Example 3 | 49 | 46 |
| Example 4 | 22 | 19 |
| Example 5 | 57 | 54 |
| Example 6 | 32 | 31 |
| Example 7 | 38 | 36 |
| Comparative | 30 | 24 |
| Example 1 | | |
| Comparative | 35 | 20 |
| Example 2 | | |
| Comparative | 70 | 32 |
| Example 3 | | |
| Comparative | 51 | 32 |
| Example 4 | | |

As is apparent from the results of Table 3, the separators of the present invention kept the film thickness with a difference within 3 μm between before and after 4000 hours of 2.5 V voltage application at 80° C., confirming that these separators were excellently heat-resistant, solvent-resistant, and stable against the long-term high temperature test. In contrast, the separators of the Comparative Examples 1 to 4 were largely thinned with a difference in the film thickness of 6 μm or more between before and after 4000 hours of voltage application, meaning that these separators were inferior in the stability against the long-term high temperature test.

### Example 8

A polyethylene terephthalate fiber of 55% crystallinity having a fiber diameter of 2.5 μm and a fiber length of 6 mm was charged into ion-exchanged water to have a concentration of 0.05% by mass in a pulper. This mixture was dispersed for 30 minutes. By so doing, a fiber dispersion A was produced. Next, a wholly aromatic polyamide fibrillated to have a fiber diameter of 0.2 μm and a fiber length of 0.6 mm, and a solvent-spinned cellulose fibrillated to have a fiber diameter of 0.5 μm and a fiber length of 1 mm, were mixed at a mass ratio of 1:1, and charged into ion-exchanged water to have a concentration of 0.05% by mass in another pulper differing from the above-mentioned pulper. This mixture was dispersed for 30 minutes. By so doing, a fiber dispersion B was produced.

The dispersion A was formed into a wet sheet by using a standard handsheet machine as defined in JIS P8222. On this sheet was formed another sheet of the dispersion B. Thereafter, the thus produced wet sheet was taken out from the handsheet machine and then dried at 130° C. by a Yankee type dryer, thereby producing a separator of the present invention.

Regarding the physical properties of the produced separator, the density was 0.40 g/cm³, the porosity was 73%, and the thickness of the separator was 30 μm.

### Example 9

A polyethylene terephthalate fiber of 73% crystallinity having a fiber diameter of 2.5 μm and a fiber length of 6 mm was charged into ion-exchanged water to have a concentration of 0.05% by mass in a pulper. This mixture was dispersed for 30 minutes. By so doing, a fiber dispersion C was produced. Next, a wholly aromatic polyimide fibrillated to have a fiber diameter of 0.2 μm and a fiber length of 0.6 mm, and a solvent-spinned cellulose fibrillated to have a fiber diameter of 0.5 μm and a fiber length of 1 mm, were mixed at a mass ratio of 1:1, and charged into ion-exchanged water to have a concentration of 0.05% by mass in another pulper differing from the above-mentioned pulper. This mixture was dispersed for 30 minutes. By so doing, a fiber dispersion D was produced.

The dispersion C was formed into a wet sheet by using a standard handsheet machine as defined in JIS P8222. On this sheet was formed another sheet of the dispersion D. Thereafter, the thus produced wet sheet was taken out from the handsheet machine and then dried at 130° C. by a Yankee type dryer, thereby producing a separator of the present invention.

Regarding the physical properties of the produced separator, the density was 0.41 g/cm³, the porosity was 73%, and the thickness of the separator was 30 μm.

### Example 10

A polyethylene terephthalate fiber of 55% crystallinity having a fiber diameter of 2.5 μm and a fiber length of 6 mm, and a wholly aromatic polyamide fibrillated to have a fiber diameter of 0.2 μm and a fiber length of 0.6 mm, were mixed at a mass ratio of 1:1, and charged into ion-exchanged water to have a concentration of 0.05% by mass in a pulper. This mixture was dispersed for 30 minutes. By so doing, a fiber dispersion E was produced. Next, a solvent-spinned cellulose fibrillated to have a fiber diameter of 0.5 μm and a fiber length of 1 mm was charged into ion-exchanged water to have a concentration of 0.05% by mass in another pulper differing from the above-mentioned pulper. This mixture was dispersed for 30 minutes. By so doing, a fiber dispersion F was produced.

The dispersion E was formed into a wet sheet by using a standard handsheet machine as defined in JIS P8222. On this sheet was formed another sheet of the dispersion F. Thereafter, the thus produced wet sheet was taken out from the handsheet machine and then dried at 130° C. by a Yankee type dryer, thereby producing a separator of the present invention.

Regarding the physical properties of the produced separator, the density was 0.39 g/cm³, the porosity was 74%, and the thickness of the separator was 30 μm.

### Example 11

A polyethylene terephthalate fiber of 55% crystallinity having a fiber diameter of 2.5 μm and a fiber length of 6 mm, and a polyphenylene sulfide fibrillated to have a fiber diameter of 0.8 μm and a fiber length of 1.5 mm, were mixed at a mass ratio of 1:1, and charged into ion-exchanged water to have a concentration of 0.05% by mass in a pulper. This mixture was dispersed for 30 minutes. By so doing, a fiber dispersion G was produced. Next, a solvent-spinned cellulose fibrillated to have a fiber diameter of 0.5 μm and a fiber length of 1 mm was charged into ion-exchanged water to have a concentration of 0.05% by mass in another pulper differing from the above-mentioned pulper. This mixture was dispersed for 30 minutes. By so doing, a fiber dispersion H was produced.

The dispersion G was formed into a wet sheet by using a standard handsheet machine as defined in JIS P8222. On this sheet was formed another sheet of the dispersion H. Thereafter, the thus produced wet sheet was taken out from the handsheet machine and then dried at 130° C. by a Yankee type dryer, thereby producing a separator of the present invention.

Regarding the physical properties of the produced separator, the density was 0.40 g/cm³, the porosity was 74%, and the thickness of the separator was 30 μm.

### Example 12

A wholly aromatic polyester fiber of 85% crystallinity fibrillated to have a fiber diameter of 0.2 μm and a fiber length of 0.6 mm was charged into ion-exchanged water to have a concentration of 0.05% by mass in a pulper. This mixture was dispersed for 30 minutes. By so doing, a fiber dispersion I was produced. Next, a solvent-spinned cellulose fibrillated to have a fiber diameter of 0.5 μm and a fiber length of 1 mm was charged into ion-exchanged water to have a concentration of 0.05% by mass in another pulper differing from the above-mentioned pulper. This mixture was dispersed for 30 minutes. By so doing, a fiber dispersion J was produced.

The dispersion I was formed into a wet sheet by using a standard handsheet machine as defined in JIS P8222. On this sheet was formed another sheet of the dispersion J. Thereafter, the thus produced wet sheet was taken out from the handsheet machine and then dried at 130° C. by a Yankee type dryer, thereby producing a separator of the present invention.

Regarding the physical properties of the produced separator, the density was 0.40 g/cm³, the porosity was 73%, and the thickness of the separator was 30 μm.

### Example 13

A wholly aromatic polyester fiber of 85% crystallinity fibrillated to have a fiber diameter of 0.2 μm and a fiber length of 0.6 mm was charged into ion-exchanged water to have a concentration of 0.05% by mass in a pulper. This mixture was dispersed for 30 minutes. By so doing, a fiber dispersion K was produced. Next, a wholly aromatic polyamide fibrillated to have a fiber diameter of 0.2 μm and a fiber length of 0.6 mm, and a solvent-spinned cellulose fibrillated to have a fiber diameter of 0.5 μm and a fiber length of 1 mm, were mixed at a mass ratio of 1:1, and charged into ion-exchanged water to have a concentration of 0.05% by mass in another pulper differing from the above-mentioned pulper. This mixture was dispersed for 30 minutes. By so doing, a fiber dispersion L was produced.

The dispersion K was formed into a wet sheet by using a standard handsheet machine as defined in JIS P8222. On this sheet was formed another sheet of the dispersion L. Thereafter, the thus produced wet sheet was taken out from the handsheet machine and then dried at 130° C. by a Yankee type dryer, thereby producing a separator of the present invention.

Regarding the physical properties of the produced separator, the density was 0.40 g/cm³, the porosity was 73%, and the thickness of the separator was 30 μm.

### Example 14

A polyethylene terephthalate fiber of 55% crystallinity having a fiber diameter 0.5 μm and a fiber length 5 mm was charged into ion-exchanged water to have a concentration of 0.05% by mass in a pulper. This mixture was dispersed for 30 minutes. By so doing, a fiber dispersion M was produced. Next, a wholly aromatic polyamide fibrillated to have a fiber diameter of 0.2 μm and a fiber length of 0.6 mm, and a solvent-spinned cellulose fibrillated to have a fiber diameter of 0.5 μm and a fiber length of 1 mm, were mixed at a mass ratio of 1:1, and charged into ion-exchanged water to have a concentration of 0.05% by mass in another pulper differing from the above-mentioned pulper. This mixture was dispersed for 30 minutes. By so doing, a fiber dispersion N was produced.

The dispersion M was formed into a wet sheet by using a standard handsheet machine as defined in JIS P8222. On this sheet was formed another sheet of the dispersion N. Thereafter, the thus produced wet sheet was taken out from the handsheet machine and then dried at 130° C. by a Yankee type dryer, thereby producing a separator of the present invention.

Regarding the physical properties of the produced separator, the density was 0.40 g/cm³, the porosity was 73%, and the thickness of the separator was 30 μm.

### Example 15

A polyethylene terephthalate fiber of 55% crystallinity having a fiber diameter of 2.5 μm and a fiber length of 6 mm was charged into ion-exchanged water to have a concentration of 0.05% by mass in a pulper. This mixture was dispersed for 30 minutes. By so doing, a fiber dispersion P was produced. Next, a wholly aromatic polyamide fibrillated to have a fiber diameter of 0.2 μm and a fiber length of 0.6 mm, and a solvent-spinned cellulose fibrillated to have a fiber diameter of 0.5 μm and a fiber length of 1 mm, were mixed at a mass ratio of 1:1, and charged into ion-exchanged water to have a concentration of 0.05% by mass in another pulper differing from the above-mentioned pulper. This mixture was dispersed for 30 minutes. By so doing, a fiber dispersion Q was produced.

The dispersion P was formed into a wet sheet by using a standard handsheet machine as defined in JIS P8222. On this sheet was formed another sheet of the dispersion Q. Thereafter, the thus produced wet sheet was taken out from the handsheet machine and then dried at 130° C. by a Yankee type dryer, thereby producing a separator of the present invention.

Regarding the physical properties of the produced separator, the density was 0.40 g/cm³, the porosity was 73%, and the thickness of the separator was 19 μm.

### Example 16

A polyethylene terephthalate fiber of 55% crystallinity having a fiber diameter of 2.5 μm and a fiber length of 6 mm was charged into ion-exchanged water to have a concentration of 0.05% by mass in a pulper. This mixture was dispersed for 30 minutes. By so doing, a fiber dispersion R was produced. Next, a wholly aromatic polyamide fibrillated to have a fiber diameter of 0.6 μm and a fiber length of 1.5 mm was charged into ion-exchanged water to have a concentration of 0.05% by mass in a pulper. This mixture was dispersed for 30 minutes. By so doing, a fiber dispersion S was produced.

Furthermore, a solvent-spinned cellulose fibrillated to have a fiber diameter of 0.5 μm and a fiber length of 1 mm was charged into ion-exchanged water to have a concentration of 0.05% by mass in another pulper differing from the above-mentioned pulper. This mixture was dispersed for 30 minutes. By so doing, a fiber dispersion T was produced.

The dispersion R was formed into a wet sheet by using a standard handsheet machine as defined in JIS P8222. On this sheet was formed another sheet of the dispersion S. Thereafter, on the sheet was formed yet another sheet of the dispersion T. The thus produced wet sheet was taken out from the handsheet machine and then dried at 130° C. by a Yankee type dryer, thereby producing a separator of the present invention.

Regarding the physical properties of the produced separator, the density was 0.40 g/cm³, the porosity was 73%, and the thickness of the separator was 35 μm.

### Example 17

A fiber comprising a polyethylene terephthalate fiber of 55% crystallinity having a fiber diameter of 2.5 μm and a fiber length of 6 mm, a fiber comprising a wholly aromatic polyamide fibrillated to have a fiber diameter of 0.2 μm and a fiber length of 0.6 mm, and a fiber comprising a solvent-spinned cellulose fibrillated to have a fiber diameter of 0.5 μm and a fiber length of 1 mm, at a mass ratio of 25:60:15, were respectively charged into ion-exchanged water to have a concentration of 0.05% by mass in a pulper. This mixture was dispersed for 30 minutes. By so doing, a fiber dispersion U was produced.

The dispersion U was supplied to both the first flow box 14 and the second flow box 15 in the multi-tank inclined type wet paper machine of FIG. 1, and the papermaking net 10 was moved to travel so that the dispersion U flowed out from the respective flow boxes to the inclined traveling part 13. In this manner, a wet sheet in which fiber layers of the same fiber composition were sequentially laminated, was formed. This sheet was dried at 130° C. by a Yankee type dryer, thereby producing a separator having a thickness of 20 μm, a density of 0.45 g/cm³, and a porosity of 70% without pinholes.

### Example 18

A fiber comprising a polyethylene terephthalate fiber of 55% crystallinity having a fiber diameter of 2.5 μm and a fiber length of 6 mm was charged into ion-exchanged water to have a concentration of 0.05% by mass in a pulper. This mixture was dispersed for 30 minutes. Thereby, a dispersion V was produced. A fiber comprising a wholly aromatic polyamide fibrillated to have a fiber diameter of 0.2 μm and a fiber length of 0.6 mm, and a fiber comprising a solvent-spinned cellulose fibrillated to have a fiber diameter of 0.5 μm and a fiber length of 1 mm, at a mass ratio of 80:20, were respectively charged into ion-exchanged water to have a concentration of 0.05% by mass in a pulper. This mixture was dispersed for 30 minutes. Thereby, a dispersion W was produced.

The dispersion V was supplied to the first flow box 14 of the multi-tank inclined type wet paper machine of FIG. 1, and the dispersion W was supplied to the second flow box 15. Next, the papermaking net 10 was moved to travel so that these dispersions flowed out from the respective flow boxes to the inclined traveling part 13. In this manner, a wet sheet in which fiber layers of different types of fibers were sequentially laminated, was formed. This sheet was dried at 130° C. by a Yankee type dryer, thereby producing a separator having a thickness of 20 μm, a density of 0.45 g/cm³, and a porosity of 69% without pinholes, the top side and the back side of which were composed of different types of fibers.

### Comparative Example 5

A polyethylene terephthalate fiber of 20% crystallinity having a fiber diameter of 2.5 μm and a fiber length of 6 mm was charged into ion-exchanged water to have a concentration of 0.05% by mass in a pulper. This mixture was dispersed for 30 minutes. By so doing, a fiber dispersion “a” was produced. Next, a wholly aromatic polyamide fibrillated to have a fiber diameter of 0.2 μm and a fiber length of 0.6 mm, and a solvent-spinned cellulose fibrillated to have a fiber diameter of 0.5 μm and a fiber length of 1 mm, were mixed at a mass ratio of 1:1, and charged into ion-exchanged water to have a concentration of 0.05% by mass in another pulper differing from the above-mentioned pulper. This mixture was dispersed for 30 minutes. By so doing, a fiber dispersion “b” was produced.

The dispersion “a” was formed into a wet sheet having a basis weight of 6 g/cm² by using a standard handsheet machine as defined in JIS P8222. On this sheet was formed another sheet of the dispersion “b” having a basis weight of 6 g/cm². Thereafter, the thus produced wet sheet was taken out from the handsheet machine and then dried at 130° C. by a Yankee type dryer, thereby producing a comparative separator.

Regarding the physical properties of the produced comparative separator, the density was 0.40 g/cm³, the porosity was 73%, and the thickness of the comparative separator was 30 μm.

### Comparative Example 6

A solvent-spinned cellulose fibrillated to have a fiber diameter of 0.5 μm and a fiber length of 1 mm was charged into ion-exchanged water to have a concentration of 0.05% by mass in a pulper. This mixture was dispersed for 30 minutes. By so doing, a fiber dispersion “c” was produced.

The dispersion “c” was formed into a wet sheet having a basis weight of 6 g/cm² by using a standard handsheet machine as defined in JIS P8222. Thereafter, the thus produced wet sheet was taken out from the handsheet machine and then dried at 130° C. by a Yankee type dryer, thereby producing a comparative separator.

Regarding the physical properties of the produced comparative separator, the density was 0.41 g/cm³, the porosity was 74%, and the thickness of the comparative separator was 32 μm.

The separators produced by the Examples 8 to 18 and the Comparative Examples 5 and 6 were evaluated in the following manner so as to make an evaluation of the quality as a separator. The values of the physical properties of the respective separators, namely, the film thickness, the density, and the porosity, are shown in Table 4.

TABLE 4

| | Film thickness | Density | |
|---|---|---|---|
| | (μm) | (g/cm³) | Porosity (%) |
| Example 8 | 30 | 0.40 | 73 |
| Example 9 | 30 | 0.41 | 73 |
| Example 10 | 30 | 0.39 | 74 |
| Example 11 | 30 | 0.40 | 74 |
| Example 12 | 30 | 0.40 | 73 |
| Example 13 | 30 | 0.40 | 73 |
| Example 14 | 30 | 0.40 | 73 |
| Example 15 | 19 | 0.40 | 73 |
| Example 16 | 35 | 0.40 | 73 |
| Example 17 | 20 | 0.45 | 70 |
| Example 18 | 20 | 0.45 | 69 |
| Comparative | 30 | 0.40 | 73 |
| Example 5 | | | |
| Comparative | 32 | 0.41 | 74 |
| Example 6 | | | |

### Assembling of Electric Double Layer Capacitors and Evaluation of Discharge Capacity and Voltage Holding Property

Electric double layer capacitors were assembled using the separators of Examples 8 to 18 and Comparative Examples 5 and 6 with a positive electrode and a negative electrode. One hundred coiled cells were produced per each type of separator. In the production of the coiled cell, activated carbon electrodes for use in electric double layer capacitors (manufactured by Hosen Co., Ltd) were used as the electrodes. In addition, a propylene carbonate solution having 1 mol/L tetraethylammonium tetrafluoroborate (manufactured by Kishida Chemical Co., Ltd.) dissolved therein was used as the electrolyte.

The produced coiled cell was subjected to a measurement of the discharge capacity with an LCR meter, at the time of initiation, after 2000 hours, and after 4000 hours, of the test. Moreover, each cell was charged at 2.5 V after 2000 hours of the test, and then the electric circuit was opened. After 24 hours, the holding voltage was examined. The test was carried out under a condition of 80° C. with an application of 2.5 V.

The obtained results are shown in Table 5.

TABLE 5

| | | Discharge | Discharge | |
|---|---|---|---|---|
| | Discharge | capacity (F) | capacity (F) | |
| | capacity (F) | after 2000 | after 4000 | Holding |
| | at initiation | hours | hours | voltage (V) |
| Example 8 | 10.0 | 9.0 | 7.4 | 2.36 |
| Example 9 | 10.3 | 9.2 | 7.5 | 2.39 |
| Example 10 | 9.9 | 8.4 | 6.7 | 2.31 |
| Example 11 | 9.8 | 8.2 | 6.6 | 2.29 |
| Example 12 | 10.4 | 9.6 | 8.0 | 2.42 |
| Example 13 | 10.5 | 9.3 | 8.1 | 2.42 |
| Example 14 | 9.9 | 8.4 | 7.3 | 2.28 |
| Example 15 | 10.1 | 8.5 | 7.5 | 2.27 |
| Example 16 | 9.8 | 8.3 | 7.0 | 2.26 |
| Example 17 | 10.0 | 9.1 | 7.5 | 2.41 |
| Example 18 | 10.2 | 9.2 | 7.5 | 2.45 |
| Comparative | 9.9 | 7.4 | 4.8 | 2.00 |
| Example 5 | | | | |
| Comparative | 10.0 | 6.9 | 3.8 | 1.86 |
| Example 6 | | | | |

As is apparent from the results of Table 5, the electric double layer capacitors using the separators of the present invention maintained sufficient discharge capacity of 6.6 F or higher, and held 2.26 V or higher voltage, even after the 4000 hours test with 2.5 V application at 80° C., confirming that these separators had excellent quality. In contrast, the electric double layer capacitors using the separators of the Comparative Examples showed large reduction in the discharge capacity, and remarkably insufficient voltage holding property, meaning that these separators were quite inferior.

From the above-mentioned results, the separators of the present invention were found to have quite excellent durability in the form of a thin film under high temperature environments in the presence of organic solvents and ionic solutions. Accordingly, the separators of the present invention were suitably used for power storage devices such as an electric double layer capacitor, and excelled in the prevention against short-circuiting between electrodes and the suppression on self-discharging.

### INDUSTRIAL APPLICABILITY

The power storage device separator of the present invention is very useful for the industry, as it has quite excellent durability in the form of a thin film for long periods of use under high temperature environments in the presence of organic solvents or ionic solutions, can be suitably used for power storage devices such as an electric double layer capacitor, and excels in the prevention against short-circuiting between electrodes and the suppression on self-discharging.

In addition, the separator of the present invention can be realized in the form of a thin film which has excellent ion permeability and low resistance, which excels in the prevention against short-circuiting between electrodes and the suppression on self-discharging, and in addition, which has excellent durability after long periods of use at high temperatures in the presence of organic solvents or ionic solutions. Accordingly, the separator of the present invention is very useful for the industry, as it can be suitably used for power storage devices, in particular, for a lithium ion secondary battery, a polymer lithium secondary battery, an electric double layer capacitor, and an aluminum electrolytic capacitor.

### BRIEF DESCRIPTION OF THE REFERENCE SYMBOLS

10 papermaking net
11 guide roller
12 guide roller
13 inclined traveling part
14 first flow box
15 second flow box
16 dispersion
17 dispersion
18 partition

1. A separator for a power storage device, wherein the separator includes a thermoplastic synthetic fiber A, a heat-resistant synthetic fiber B, and a natural fiber C, and the thermoplastic synthetic fiber A comprises a polyester fiber of 50% or higher crystallinity.

2. The separator for a power storage device according to claim 1, wherein said thermoplastic synthetic fiber A comprises at least one type of material selected from a polyethylene terephthalate, a polybutylene terephthalate, and a wholly aromatic polyalylate, of 50% or higher crystallinity.

3. The separator for a power storage device according to claim 1, wherein said heat-resistant synthetic fiber B comprises at least one type of material selected from a wholly aromatic polyamide, a wholly aromatic polyester, a semiaromatic polyamide, a polyphenylene sulfide, and a poly-p-phenylene benzobisoxazole.

4. The separator for a power storage device according to claim 1, wherein the blend ratio is such that said thermoplastic synthetic fiber A accounts for 25 to 50% by mass, said heat-resistant synthetic fiber B accounts for 60 to 10% by mass, and said natural fiber C accounts for 15 to 40% by mass.

5. The separator for a power storage device according to claim 1, wherein said thermoplastic synthetic fiber A has a fiber diameter of 5 μm or smaller and a fiber length of 10 mm or shorter.

6. The separator for a power storage device according to claim 1, wherein said heat-resistant synthetic fiber B is fibrillated to have a fiber diameter of 1 μm or smaller and a fiber length of 3 mm or shorter.

7. The separator for a power storage device according to claim 1, wherein said natural fiber C is a solvent-spinned cellulose that is fibrillated to have a fiber diameter of 1 μm or smaller and a fiber length of 3 mm or shorter.

8. The separator for a power storage device according to claim 1, wherein said separator comprises entangled fibers of a thermally fused thermoplastic synthetic fiber A, a fibrillated heat-resistant synthetic fiber B and/or a fibrillated natural fiber C.

9. The separator for a power storage device according to claim 1, wherein said separator has a film thickness of 60 μm or thinner.

10. The separator for a power storage device according to claim 1, wherein said separator has a density from 0.2 to 0.7 g/cm³.

11. The separator for a power storage device according to claim 1, wherein said separator has an air permeability of 100 seconds/100 ml or lower.

12. The separator for a power storage device according to claim 1, wherein said power storage device is a lithium ion secondary battery, a lithium ion capacitor, a polymer battery, or an electric double layer capacitor.

13. A separator for a power storage device, wherein the separator comprises a lamination of two or more fiber layers, and at least one of these fiber layers includes a polyester fiber of 50% or higher crystallinity.

14. The separator for a power storage device according to claim 13, wherein said fiber layer including the polyester fiber of 50% or higher crystallinity also contains another type of synthetic fiber.

15. The separator for a power storage device according to claim 13, wherein said polyester fiber is at least one type of material selected from a polyethylene terephthalate, a polybutylene terephthalate, and a wholly aromatic polyalylate, of 50% or higher crystallinity.

16. The separator for a power storage device according to claim 13, wherein said polyester fiber and said synthetic fiber have fiber diameters of 5 μm or smaller and fiber lengths of 10 mm or shorter.

17. The separator for a power storage device according to claim 14, wherein said synthetic fiber is at least one type of material selected from a wholly aromatic polyamide, a wholly aromatic polyester, a semiaromatic polyamide, a polyphenylene sulfide, a poly-p-phenylene benzobisoxazole, a polyethylene, and a polypropylene.

18. The separator for a power storage device according to claim 13, wherein said fiber layer is made by combining layers by lamination on a papermaking net with use of an inclined wire type paper machine having two or more heads.

19. The separator for a power storage device according to claim 13, wherein said fiber layer is made by combining layers by lamination on a papermaking net with use of a multi-tank inclined type wet paper machine that is capable of forming a plurality of layers at the same time with a structure such that a lower part of a second flow box is positioned in a vicinity of a crossing part between the waterline in a first flow box and the papermaking net.

20. The separator for a power storage device according to claim 13, wherein said power storage device is any one of a lithium ion secondary battery, a polymer lithium secondary battery, an electric double layer capacitor, and an aluminum electrolytic capacitor.
